(19) United States
(12) Patent Application Publication
(10) Pub. No.: US 2024/0324813 A1
(43) Pub. Date: Oct. 3, 2024

(54) SMOKELESS COOKING APPLIANCE

(71) Applicant: Jie FAN, Jiujiang (CN)

(72) Inventor: Jie FAN, Jiujiang (CN)

(21) Appl. No.: 18/743,479

(22) Filed: Jun. 14, 2024

Related U.S. Application Data
(63) Continuation-in-part of application No. PCT/CN2022/127247, filed on Oct. 25, 2022.

(51) Int. Cl. A47J 37/06

(52) U.S. Cl. CPC A47J 37/06

(57) ABSTRACT

The present disclosure provides a smokeless cooking appliance, including a cooking assembly. A fan flue is mounted above the cooking assembly in a crossing manner. A lower surface of the fan flue is provided with smoke inlets right above the cooking assembly. Smoke extraction devices are mounted in the smoke inlets. Two air guide pipe fittings are disposed below the cooking assembly. Air inlets of the two air guide pipe fittings are respectively in communication with two lower ports of the fan flue. Air outlets of the two air guide pipe fittings are respectively disposed on two sides of an upper surface of the cooking assembly.

### CROSS REFERENCE

The present application is a continuation in part of International (PCT) Patent Application No. PCT/CN2022/127247 filed on Oct. 25, 2022, the entire content of which is hereby incorporated by reference in its entirety.

### TECHNICAL FIELD

The present disclosure relates to cooking appliances, and particularly relates to a smokeless cooking appliance.

### BACKGROUND

Some household cooking appliances, such as home frying pans, baking pans and so on, allow for cooking and eating simultaneously. When used in restaurants, common household electric frying pans perform heating using heating tubes. During the heating of food, grease of the food flows out and drips on the heating tubes, producing a lot of oil smoke. However, since there are no exhaust hoods provided in general family restaurants, the oil smoke will fly into an indoor environment, causing pollution. In view of the above problem, in a grilling appliance in the prior art, an oil smoke extraction assembly is provided on one side of a grilling plate, and an air outlet is provided on the other side; an air flue is formed between the oil smoke extraction assembly and the air outlet in a grilling plate body, and an airflow circulation is formed on the outside. However, in a place with a relatively high heating temperature in the middle of the grilling plate, oil smoke diffuses upward along with hot vapor of the food, the oil smoke extraction assembly on the side does not completely suck the oil smoke in, which causes a part of oil smoke to diffuse into the indoor environment. In addition, the distance between the air outlet and the oil smoke extraction assembly is relatively long, and the oil smoke does not completely enter the airflow circulation, thereby limiting the capability of cleaning the oil smoke.

### SUMMARY

An objective of the present disclosure is to provide a smokeless cooking appliance, which has double oil smoke filtering passages and realizes efficient purification of oil smoke.

In order to achieve the above objective, the present disclosure provides the following technical solutions:

a smokeless cooking appliance comprises: a cooking assembly (4); a fan flue (2), wherein the fan flue (2) is disposed above a heating region of the cooking assembly (4) in a crossing manner, the fan flue (2) is provided with smoke inlets (24), the smoke inlets (24) are disposed above the heating region of the cooking assembly (4), a first downward air flue (25) and a second downward air flue (26) are disposed downward on the fan flue (2) along two sides of the smoke inlets (24) respectively, and lower end portions of the first downward air flue (25) and the second downward air flue (26) are provided with smoke outlets respectively; smoke extraction devices (5), wherein the smoke extraction devices (5) are mounted at the smoke inlets (24), and the smoke extraction devices (5) are respectively in communication with the smoke outlets of the first downward air flue (25) and the second downward air flue (26); and two air guide pipe fittings (3), wherein air inlets (35) of the two air guide pipe fittings (3) are respectively in communication with the smoke outlets of the first downward air flue (25) and the second downward air flue (26); and each of the air guide pipe fittings (3) is provided with air outlets (36), and the air outlets (36) are respectively located on two sides of the cooking assembly (4).

Further, a plurality of flue baffles (33) are disposed inside the air guide pipe fittings (3) along a direction of a smoke pipe, the flue baffles (33) divide the interiors of the air guide pipe fittings (3) into a plurality of air cavities (34), and each of the air cavities (34) corresponds to one air outlet (36) of the air guide pipe fittings.

Further, each of the air outlets (36) respectively corresponds to an end portion of each of the air cavities (34), and the air outlets (36) of the two air guide pipe fittings (3) are respectively disposed along edges of the cooking assembly (4).

Further, smoke guiding devices (14) are disposed at the air outlets (36), the air outlets (36) are correspondingly in communication with the smoke guiding devices (14), and smoke guiding ports of the smoke guiding devices (14) are disposed toward the smoke inlets (24).

Further, the smokeless cooking appliance comprises wind gathering devices (10), wherein the air outlets (36) of the air guide pipe fittings (3) are in communication with inner cavities of the wind gathering devices (10); the wind gathering devices (10) are provided with a plurality of smoke discharge windows (101) for discharging oil smoke, and the smoke discharge windows (101) are disposed toward the smoke extraction devices (5); and wind gathering plates (102) are disposed on edges of the smoke discharge windows (101) in a protruding manner, wind gathering passages (103) are formed between the wind gathering plates (102), and a cross-sectional area of each of the wind gathering passages (103) gradually decreases along an extending direction of the wind gathering plates (102); and the wind gathering passages (103) are in one-to-one correspondence with the smoke guiding ports, and openings of the wind gathering passages (103) are closely attached to the smoke guiding ports.

Further, a plurality of air flue structures (104) are formed inside the wind gathering devices (10) along a height direction; bottom ends of the air flue structures (104) correspond to bottom openings to form wide smoke inlet ends (1041), and one side of the air flue structures (1041) along the smoke discharge windows (101) gradually and smoothly narrows down and forms conical passages, such that narrow smoke outlet ends (1042) are formed at one end of the air flue structures (104) corresponding to the smoke discharge windows (101); and a cross-sectional area of each of the narrow smoke outlet ends (1042) is smaller than a cross-sectional area of the wide smoke inlet ends (1041).

Further, the plurality of air flue structures (104) that are not in communication with each other are disposed inside the wind gathering devices (10) along a length direction thereof; and a bottom opening of each of the air flue structures (104) is correspondingly in communication with one air outlet (36) of the air guide pipe fittings (3).

Further, bottom ends of the wind gathering plates (102) are fixedly connected to the edges of the smoke discharge windows (101), and top ends of the wind gathering plates (102) are of a pointed end structure.

Further, the smokeless cooking appliance comprises a shell (1), wherein an upper portion of the shell (1) is provided with an accommodating cavity (11), two sides of the accommodating cavity (11) are provided with a first through hole (12) and a second through hole (13) respectively, the cooking assembly (4) is mounted in the accommodating cavity (11), the two air guide pipe fittings (3) are mounted below the shell (1) respectively, and two lower ports of the fan flue (2) are respectively in communication with the air guide pipe fittings (3) via the first through hole (12) and the second through hole (13).

Further, the smoke guiding devices (14) are disposed on an upper surface of the shell (1) corresponding to the air outlets (36) of the air guide pipe fittings (3), and the smoke guiding devices (14) and the upper surface of the shell (1) are integrally formed or fixedly connected.

Further, the cooking assembly (4) comprises a heating plate (40), a first connection box (41) and a second connection box (42) are respectively disposed on two sides of the heating plate (40), a third through hole (411) is provided at a position of the first connection box (41) corresponding to the first through hole (12), and a fourth through hole (421) is provided at a position of the second connection box (42) corresponding to the second through hole (13); and the two lower ports of the fan flue (2) are respectively inserted in the third through hole (411) and the fourth through hole (421).

Further, an oil collecting tray (8) for collecting oil and impurities dropping from the heating plate (40) is disposed below the heating plate (40), and the oil collecting tray (8) is mounted in the accommodating cavity (11).

Further, two baffles (20) are disposed inside a cross beam of the fan flue (2), the two baffles (20) divide the fan flue (2) into two spaces that are not internally in communication with each other, fan mounting grooves (21) are respectively disposed at positions in the two spaces correspondingly right above the cooking assembly (4), the fan mounting grooves (21) are in communication with the interior of the fan flue (2), the smoke extraction devices (5) are mounted in the two fan mounting grooves (21) respectively, and air outlets of the two smoke extraction devices (5) are respectively in communication with two ports at bottoms of the fan flue (2).

Further, the fan flue (2) comprises a flue main body (22), a flue cover plate (23) is detachably mounted at a bottom of the flue main body (22), the fan mounting grooves (21) are disposed in the flue main body (22), the smoke inlets (24) are disposed on the flue cover plate (23), and the smoke inlets (24) correspond to positions of the fan mounting grooves (21).

Further, first filter screens (6) are mounted at the smoke inlets (24) and used for the adsorption and filtering of oil smoke.

Further, the smokeless cooking appliance comprises a base (7), wherein the base (7) is fixedly connected to a lower portion of the shell (1), and the air guide pipe fittings (3) are accommodated inside the base (7).

Further, the smoke extraction devices (5) are negative-pressure air blowers.

Further, each of the first filter screens (6) comprises a filter screen frame (61), a filter screen (62) is mounted on an inner side of the filter screen frame (61), a mounting through hole (63) is provided in the center of the filter screen (62), and an oil storage cap (64) is detachably mounted in the mounting through hole (63).

Further, an edge of an opening of the oil storage cap (64) extends outward to form a brim (641), and the outer diameter of the brim (641) is greater than the inner diameter of the mounting through hole (63).

Further, two convex blocks (65) protruding outward are provided at a bottom of the filter screen frame (61), facilitating rotary snap-fitting of the first filter screens (6) during the mounting.

Based on the analysis, the present disclosure discloses a smokeless cooking appliance, the fan flue is disposed above the cooking assembly, the two lower ports of the fan flue are respectively connected to the air guide pipe fittings, the air outlets of the air guide pipe fittings are disposed on the two sides of an upper surface of the cooking assembly, oil smoke produced from the upper surface of the cooking assembly is sucked in via the smoke extraction devices in the fan flue and passes through the air guide pipe fittings, and the oil smoke discharged from the air outlets of the air guide pipe fittings is sucked into the interior of the fan flue again by the smoke extraction devices to form a circulation of the oil smoke, thereby reducing the oil smoke overflowing out.

The interiors of the air guide pipe fittings are divided into the plurality of air cavities, and the air outlet of each of the air cavities is disposed along edges of the cooking assembly, such that “wind curtains” can be formed on the edges of the cooking assembly, further reducing the oil smoke produced by the cooking assembly overflowing out.

The smoke guiding devices are disposed on outer sides of the air outlets, the smoke guiding ports of the smoke guiding devices are disposed toward the smoke inlets, and discharge directions of oil smoke are guided at the smoke guiding ports of the smoke guiding devices into the smoke inlets to form the circulation of the oil smoke, such that the oil smoke can be sucked into the fan flue again, thereby further reducing the oil smoke produced by the cooking assembly overflowing out.

Furthermore, the oil smoke filter screens are disposed at the smoke inlets of the fan flue for the adsorption and filtering of ingredients of the oil smoke, such that the oil smoke produced in the cooking process is adsorbed to the interior of a body, and the oil smoke discharged to the indoors is reduced. In addition, the filter screens are disposed detachably, thereby facilitating cleaning or replacement.

The oil collecting tray is disposed below the heating plate and used for collecting oil and impurities dropping from the heating plate. A sink is disposed the upper surface of the shell and located below the oil collecting tray, such that oil can be directly stored in the sink or stored in an oil storage box placed in the sink, facilitating cleaning.

By the technical solutions of the present disclosure, the adsorption and circulation of the oil smoke are improved, the filter screens are added in an oil smoke circulation passage of the body for the adsorption and filtering of the ingredients of the oil smoke, thereby improving the oil smoke adsorption capability and greatly reducing the possibility of the oil smoke overflowing out; and in addition, both the replacement time of the oil smoke filter screens and work intensity of cleaning an oil smoke body are greatly reduced, and at the same time, the costs are saved.

### BRIEF DESCRIPTION OF THE DRAWINGS

The accompanying drawings, which constitute a part of this application, are used for providing a further understanding of the present disclosure; and schematic embodiments of the present disclosure and descriptions thereof are intended to explain the present disclosure and are not construed to unduly limit the present disclosure. In the drawings:

FIG. 1 is a structural schematic view of Embodiment 1 according to the present disclosure;

FIG. 2 is an exploded structural schematic view of Embodiment 1 according to the present disclosure;

FIG. 3 is a structural schematic view of a shell of Embodiment 1 according to the present disclosure;

FIG. 4 is a structural schematic view of a cooking assembly of Embodiment 1 according to the present disclosure;

FIG. 5 is a structural schematic view of an air guide pipe fitting of Embodiment 1 according to the present disclosure;

FIG. 6 is an exploded structural schematic view of the air guide pipe fitting of Embodiment 1 according to the present disclosure;

FIG. 7 is an exploded structural schematic view of a fan flue of Embodiment 1 according to the present disclosure;

FIG. 8 is a schematic view of a circulation of air in the fan flue and a flue pipe of Embodiment 1 according to the present disclosure;

FIG. 9 is a structural schematic view of a sectional structure at A-A shown in FIG. 1.

FIG. 10 is a structural schematic view of a sectional structure at B-B shown in FIG. 1.

FIG. 11 is a structural schematic view of an oil collecting tray of Embodiment 1 according to the present disclosure;

FIG. 12 is a structural schematic view of a first filter screen of Embodiment 1 according to the present disclosure;

FIG. 13 is an exploded structural schematic view of Embodiment 2 according to the present disclosure;

FIG. 14 is a cross-sectional view of Embodiment 2 according to the present disclosure;

FIG. 15 is a schematic view of an airflow circulation of Embodiment 2 according to the present disclosure;

FIG. 16 is a cross-sectional view of an air guide pipe fitting and a wind gathering device in a connected state according to Embodiment 2 of the present disclosure;

FIG. 17 is a structural schematic view of the wind gathering device of Embodiment 2 according to the present disclosure; and

FIG. 18 is a cross-sectional view of the wind gathering device of Embodiment 2 according to the present disclosure.

Descriptions of the reference signs:
1—shell;
11—accommodating cavity; 12—first through hole; 13—second through hole; 14—smoke guiding device; 15—sink;
2—fan flue;
20—baffle; 21—fan mounting groove; 22—flue main body; 23—flue cover plate; 24—smoke inlet; 25—first downward air flue; 26—second downward air flue;
3—air guide pipe fitting;
31—pipe main body; 32—pipe cover plate; 33—flue baffle; 34—air cavity; 35—air inlet; 36—air outlet; 37—second filter screen;
4—cooking assembly;
40—heating plate;
41—first connection box; 411—third through hole;
42—second connection box; 421—fourth through hole;
43—grill mesh;
5—smoke extraction device;
6—first filter screen;
61—filter screen frame; 62—filter screen; 63—mounting through hole; 64—oil storage cap; 641—brim; 65—convex block;
7—base;
8—oil collecting tray; 81—oil drain mesh;
9—oil storage box;
10—wind gathering device;
101—smoke discharge window; 102—wind gathering plate; 103—wind gathering passage;
104—air flue structure; 1041—wide smoke inlet end; and 1042—narrow smoke outlet end.

### DETAILED DESCRIPTION OF EMBODIMENTS

The present disclosure will be described in detail below with reference to the accompanying drawings and embodiments. Each example is provided by way of an explanation of the present disclosure, not a limitation to the present disclosure. In fact, those skilled in the art will recognize that modifications and variations can be made in the present disclosure without departing from the scope or spirit of the present disclosure. For example, features shown or described as part of one embodiment may be used in another embodiment to produce yet another embodiment. Therefore, it is intended that the present disclosure includes such modifications and variations as come within the scope of the appended claims and their equivalents.

In the description of the present disclosure, the orientations or positional relationships indicated by the terms “longitudinal”, “transverse”, “upper”, “lower”, “front”, “rear”, “left”, “right”, “vertical”, “horizontal”, “top”, “bottom”, etc. are based on the orientations or positional relationships shown in the drawings, and are only for the convenience of describing the present disclosure, rather than requiring that the present disclosure must be constructed and operated in a specific orientation, so they cannot be interpreted as limitations to the present disclosure. The terms “linked”, “connected” and “arranged” used in the present disclosure should be understood in a broad sense, for example, it can be fixedly connected or detachably connected, it can be directly connected or indirectly connected through an intermediate component, and it also can be a cable connection, a radio connection or a wireless communication signal connection. Those of ordinary skill in the art can understand the specific meanings of the above terms according to specific situations.

One or more examples of the present disclosure are shown in the accompanying drawings. The detailed description uses numerical and letter signs to refer to features in the drawings. Similar or like signs in the drawings and descriptions have been used to refer to similar or like parts of the present disclosure. As used herein, the terms “first”, “second”, “third” and the like are used interchangeably to distinguish one member from another and are not intended to denote the location or importance of individual members.

### Embodiment 1

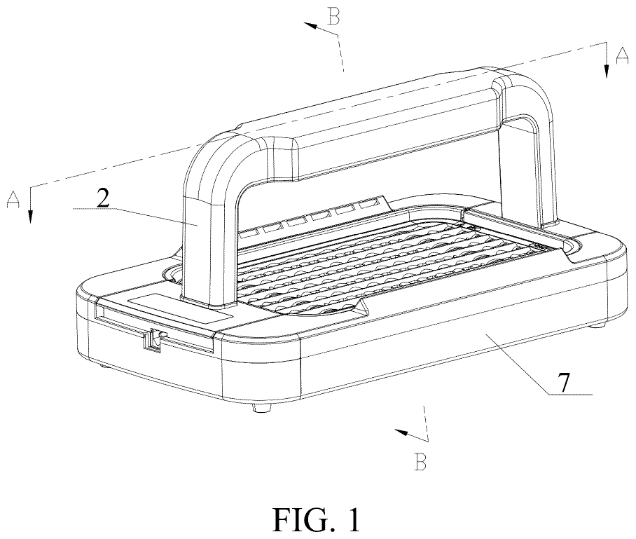

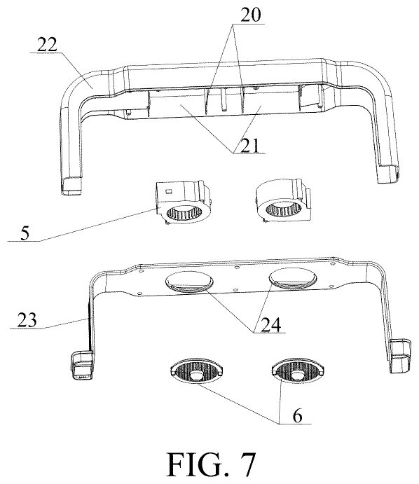

As shown in FIG. 1 to FIG. 11, according to an embodiment of the present disclosure, there is provided a smokeless cooking appliance, including a shell 1. An upper portion of the shell 1 is provided with an accommodating cavity 11, two sides of the accommodating cavity 11 are provided with a first through hole 12 and a second through hole 13 respectively, the cooking assembly 4 is mounted above the shell 1, and the cooking assembly 4 is mounted in the accommodating cavity 11; and the cooking assembly 4 includes a heating plate 40, a first connection box 41 and a second connection box 42 are respectively disposed on two sides of the heating plate 40, a third through hole 411 is provided at a position of the first connection box 41 corresponding to the first through hole 12, and a fourth through hole 421 is provided at a position of the second connection box 42 corresponding to the second through hole 13.

A fan flue 2 is disposed above the cooking assembly 4 in a crossing manner. The fan flue 2 is integrally of a C-shaped hollow structure with a straight side. Two baffles 20 are disposed inside a cross beam of the fan flue 2. The two baffles 20 divide the fan flue 2 into two spaces that are not internally in communication with each other. Fan mounting grooves 21 are respectively disposed at positions in the two spaces correspondingly right above the cooking assembly 4, and the fan mounting grooves 21 are in communication with the interior of the fan flue 2. A first downward air flue 25 and a second downward air flue 26 are disposed downward on the fan flue 2 along two sides of the two fan mounting grooves 21 respectively, end portions of the first downward air flue 25 and the second downward air flue 26 are provided with smoke outlets respectively, smoke extraction devices 5 are mounted in the two fan mounting grooves 21 respectively, and air outlets of the two smoke extraction devices 5 are respectively in communication with the smoke outlets of the first downward air flue 25 and the second downward air flue 26. The smoke outlet of the first downward air flue 25 of the fan flue 2 is inserted in the third through hole 411 of the first connection box 41, and the smoke outlet of the second downward air flue 26 of the fan flue 2 is inserted in the fourth through hole 421 of the second connection box 42. For the convenience of the mounting of the smoke extraction devices 5, the fan flue 2 includes a flue main body 22, a flue cover plate 23 is detachably mounted at a bottom of the flue main body 22, the two baffles 20 are disposed inside the flue main body 22, the two fan mounting grooves 21 are respectively disposed on two sides of the two baffles 20, smoke inlets 24 are disposed at positions of the flue cover plate 23 corresponding to the two fan mounting grooves 21 respectively, and first filter screens 6 are detectably mounted at groove openings of the two fan mounting grooves 21 and used for the adsorption of oil smoke. The two first filter screens 6 are respectively snap-fitted to edges of the smoke inlets 24.

The first filter screen 6 includes a filter screen frame 61, snap-fitting keys 611 are provided at an upper end of the filter screen frame 61, correspondingly, snap-fitting grooves 241 are provided at an edge of the smoke inlet 24, and the snap-fitting keys 611 are snap-fitted with the snap-fitting grooves 241 to achieve detachable snap-fitting between the first filter screen 6 and the flue cover plate 23. A filter screen 62 with vent holes is mounted on an inner side of the filter screen frame 61. The center of the filter screen 62 is recessed downward relative to an edge. A mounting through hole 63 is provided in the center of the filter screen 62. An oil storage cap 64 is mounted in the mounting through hole 63. An edge of an opening of the oil storage cap 64 extends outward to form a brim 641. The outer diameter of the brim 641 is greater than the inner diameter of the mounting through hole 63, such that the oil storage cap 64 is snap-fitted into the mounting through hole 63 when the oil storage cap 64 is mounted to the interior of the mounting through hole 63 from above the mounting through hole 63, greasy dirt flowing down from a surface of the filter screen 62 is stored in the oil storage cap 64, preventing the greasy dirt from dripping on the cooking assembly 4. Two convex blocks 65 protruding outward are further provided at a bottom of the filter screen frame 61, facilitating rotary snap-fitting of the first filter screens 6 during the mounting.

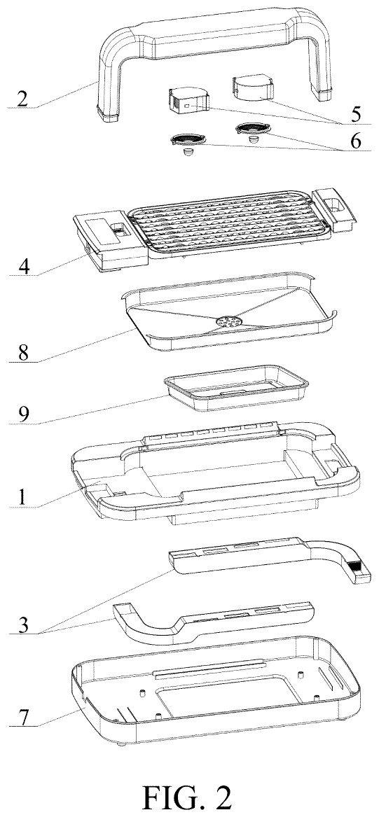

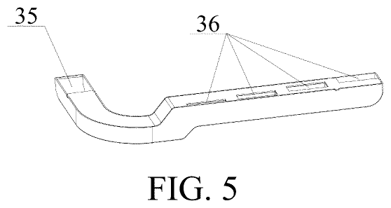

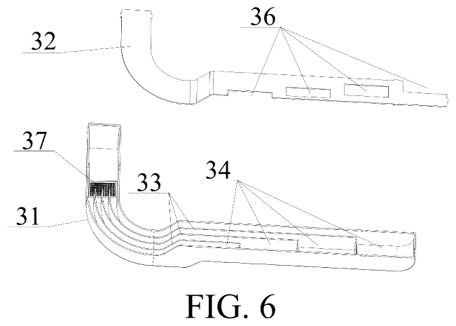

As shown in FIG. 2, two air guide pipe fittings 3 are mounted below the shell 1. As shown in FIG. 5, the air guide pipe fitting 3 is of an L-shaped structure. The air guide pipe fitting 3 includes a pipe main body 31 and a pipe cover plate 32. The pipe cover plate 32 is covered on the pipe main body 31. One end of the air guide pipe fitting 3 is provided with an air inlet 35, and the air inlets 35 of the two air guide pipe fittings 3 respectively correspond to positions of the first through hole 12 and the second through hole 13 of the shell 1 and are respectively in communication with the first through hole and the second through hole. As shown in FIG. 6, three flue baffles 33 are disposed inside the pipe main body 31 to divide the interior of the pipe main body 31 into four air cavities 34, and tail ends of the air cavities 34 are sequentially arranged along a length direction of the pipe main body 31. When the pipe cover plate 32 is covered on the pipe main body 31, the air inlet 35 is formed between one end of the pipe cover plate 32 and the pipe main body 31, four air outlets 36 are provided on a plate surface of the other end of the pipe cover plate 32, and each of the air outlets 36 corresponds to a tail end of one of the air cavities 34 inside the pipe main body 31. Oil smoke enters the four air cavities 34 from the air inlet 35 of the air guide pipe fitting 3, flows to tail ends of the air cavities 34 and is discharged from the corresponding air outlets 36 of the air cavities 34. The multiple air outlets 36 are disposed on the pipe main body 31 along the length direction, such that the oil smoke in the air guide pipe fittings 3 can be discharged along the length direction in a distributed mode.

A second filter screen 37 is further mounted inside the air guide pipe fitting 3, and the second filter screen 37 is mounted at the air inlets of the four air cavities 34 to filter the oil smoke sucked into the interior of the air guide pipe fitting 3.

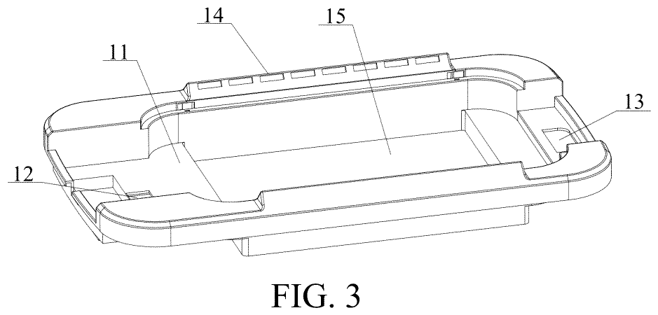

As shown in FIG. 3, smoke guiding devices 14 are respectively disposed on two sides of an upper surface of the shell 1 corresponding to positions of the air outlets 36 of the two air guide pipe fittings 3, and smoke guiding ports of the smoke guiding devices 14 are disposed toward the smoke inlets 24 of the fan flue 2 and used for guiding oil smoke toward the smoke extraction devices 5, thereby reducing the oil smoke discharged to the indoors.

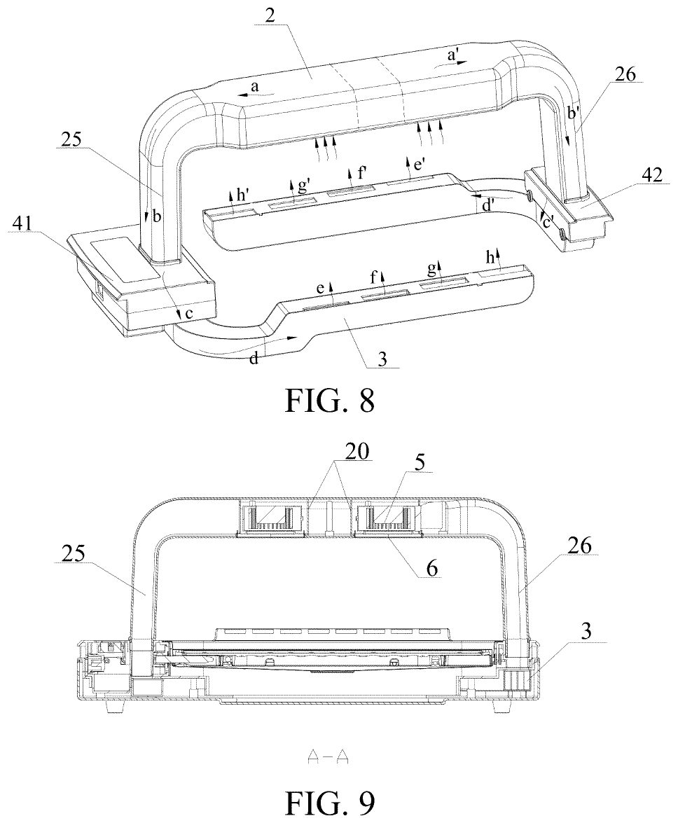

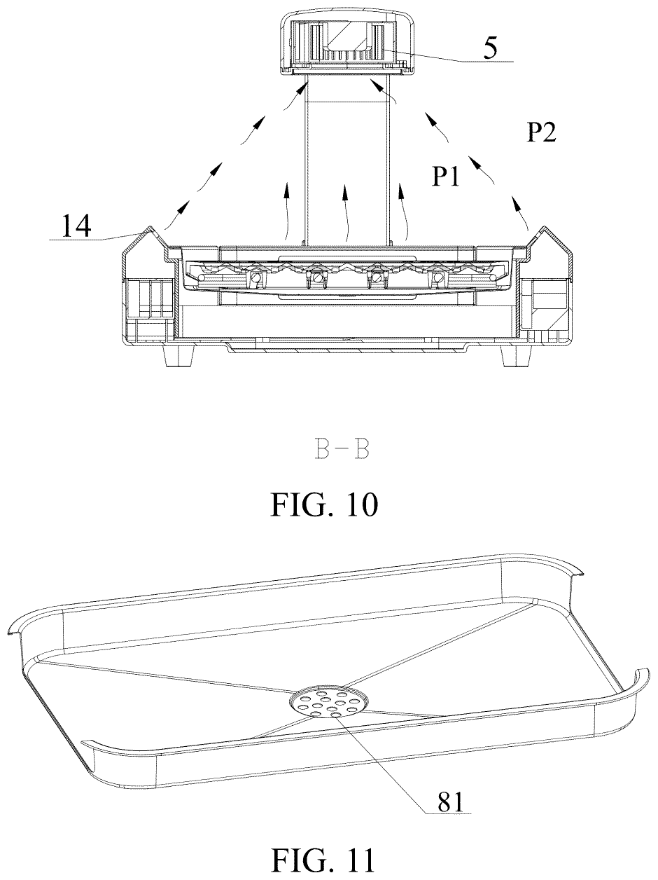

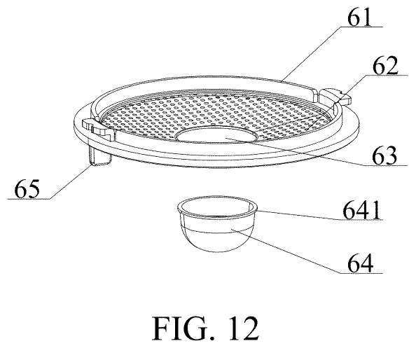

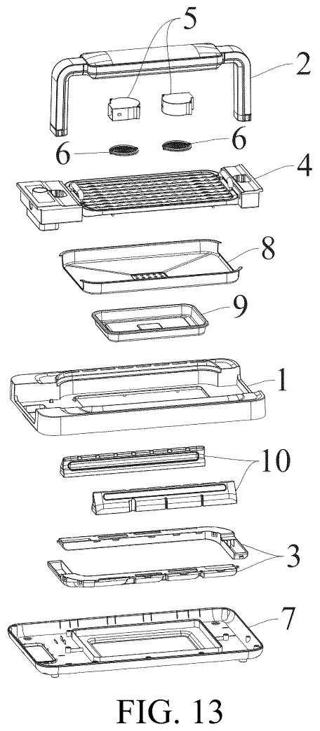

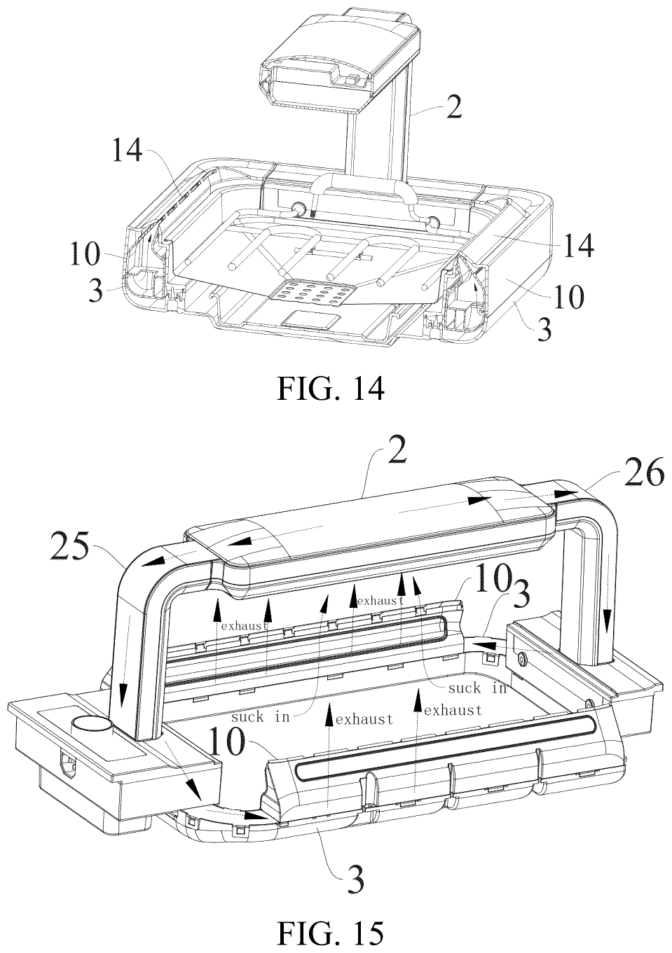

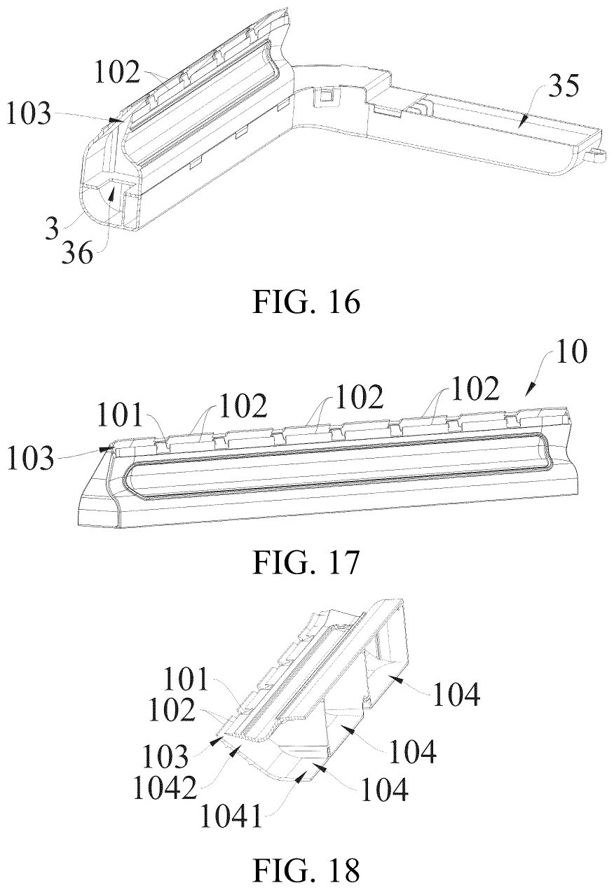

As shown in FIG. 8, two ends of the fan flue 2 are respectively in communication with the air guide pipe fittings 3 via the first connection box 41 and the second connection box 42. During the running, the smoke extraction devices 5 in the fan flue 2 suck air below into the interior of the fan flue 2. On one side of the first connection box 41, wind flows along a path a-b-c-d and is discharged into the air along e, f, g and h and sucked in again by the smoke extraction devices 5 via the smoke guiding devices 14, forming a circulation loop of the oil smoke. Similarly, on one side of the second connection box 42, wind flows along a path a′-b′-c′-d′ and is discharged into the air along e′, f, g′ and h′ and sucked in again by the smoke extraction devices 5 via the smoke guiding devices 14, forming a circulation loop of the oil smoke. As shown in FIG. 10, the pressure intensity of the air inside the circulation of oil smoke is P1, and the pressure intensity of the air outside the circulation of oil smoke is P2. Since a wind speed inside the circulation of oil smoke is higher than a wind speed outside the circulation of oil smoke, the pressure intensity P2 of the air outside the circulation of oil smoke is higher than the pressure intensity P1 of the air inside the circulation of oil smoke, such that the possibility of the oil smoke overflowing out will be reduced. The smoke guiding devices 14 are sequentially arranged on the two sides of the cooking assembly 4 along the first connection box 41 to the second connection box 42. Air between the smoke guiding devices 14 and the smoke extraction devices 5 circulates to form “wind curtains”. Since the pressure intensity P2 outside the “wind curtains” is higher than the pressure intensity P1 inside the “wind curtains”, the possibility of the oil smoke inside the “wind curtains” overflowing out is reduced.

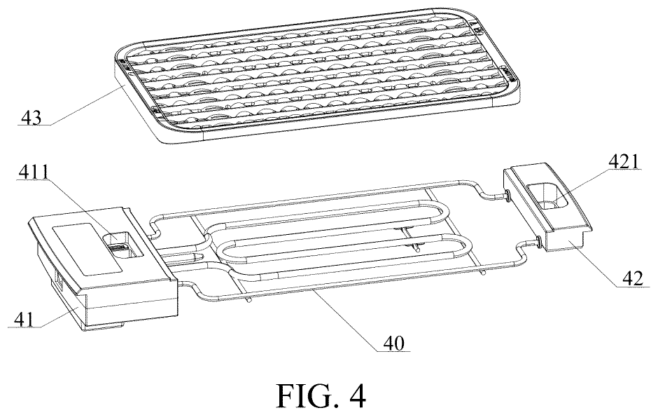

As shown in FIG. 4, the cooking assembly 4 further includes a grill mesh 43. The grill mesh 43 is disposed above the heating plate 40. Grooves are provided at a lower portion of the grill mesh 43 and are snap-fitted with heating tubes of the heating plate 40. A circuit board is disposed in the interior of the first connection box 41. The circuit board is electrically connected with the smoke extraction devices 5 and the heating plate 40 respectively. The circuit board is further provided with an electrical connector for being connected to an external power supply.

As shown in FIG. 2, an oil collecting tray 8 for collecting oil and impurities dropping from the heating plate 40 is disposed below the cooking assembly 4. The oil collecting tray 8 is mounted in the accommodating cavity 11. An oil drain mesh 81 is disposed in the middle of the oil collecting tray 8. As shown in FIG. 11, an inner surface at a bottom of the oil collecting tray 8 is inclined toward the oil drain mesh 81, such that greasy dirt on the surface of the oil collecting tray 8 flows toward the oil drain mesh 81. A sink 15 is disposed on the upper surface of the shell 1 and located below the oil collecting tray 8. An oil storage box 9 is mounted in the sink 15 and used for storing oil flowing out of the oil collecting tray 8. When the oil in the oil storage box 9 has been accumulated for some time, the oil storage box can be directly taken out for cleaning, thereby facilitating cleaning. The two air guide pipe fittings 3 are respectively located on two sides of an outer surface of the sink 15, such that an internal structure is more compact.

As shown in FIG. 2, the present disclosure further includes a base 7. The base 7 is fixedly connected to the lower portion of the shell 1. The sink 15 of the shell 1 and the air guide pipe fittings 3 are accommodated in the interior of the base 7.

Preferably, the smoke extraction devices 5 in the present disclosure adopt negative-pressure air blowers.

From the above description, it can be seen that the above embodiment of the present disclosure achieves the following technical effects:
1. the fan flue 2 is disposed above the cooking assembly 4, the two lower ports of the fan flue 2 are respectively connected to the air guide pipe fittings 3, the air outlets 36 of the air guide pipe fittings 3 are disposed on the two sides of an upper surface of the cooking assembly 4, oil smoke produced from the upper surface of the cooking assembly 4 is sucked in via the smoke extraction devices 5 in the fan flue and passes through the air guide pipe fittings 3, and the oil smoke discharged from the air outlets of the air guide pipe fittings 3 is sucked into the interior of the fan flue 2 again by the smoke extraction devices 5 to form a circulation of the oil smoke, thereby reducing the oil smoke outflowing out;
2. The interiors of the air guide pipe fittings 3 are divided into the plurality of air cavities 34, and the air outlets 36 of the air cavities 34 are respectively disposed along the edges of the cooking assembly 4, such that the “wind curtains” are formed on the edges of the cooking assembly 4, further reducing the oil smoke produced by the cooking assembly 4 overflowing out;
3. The smoke guiding devices 14 are disposed on the outer sides of the air outlets 36, the smoke guiding ports of the smoke guiding devices 14 are disposed toward the smoke inlets 24, and discharge directions of oil smoke are guided at the smoke guiding ports of the smoke guiding devices 14 into the smoke inlets 24 to form the circulation of the oil smoke, such that the oil smoke can be sucked into the fan flue 2 again, thereby further reducing the oil smoke produced by the cooking assembly 4 overflowing out;
4. the oil smoke filter screens are disposed at the smoke inlets 24 of the fan flue for the adsorption and filtering of ingredients of the oil smoke, such that the oil smoke produced in the cooking process is adsorbed to the interior of the body, and the oil smoke discharged to the indoors is reduced. In addition, the filter screens are detachably disposed, thereby facilitating cleaning or replacement; and
5. The oil collecting tray 8 is disposed below the heating plate 40 and collects oil and impurities dropping from the heating plate 40, the sink 15 is disposed below the upper surface of the shell 1 and located below the oil collecting tray 8, the oil storage box 9 is mounted in the sink 15, and when the oil in the oil storage box 9 has been accumulated for some time, the oil storage box can be directly taken out for cleaning, thereby facilitating cleaning.

Compared with the prior art, the smokeless cooking appliance of the present disclosure has double oil smoke filtering passages, the circulations is formed between the oil smoke outlets of the double oil smoke filtering passages and the oil smoke inlets to achieve circulation and filtering of the oil smoke, and in the design of the present disclosure, the “wind curtains” are formed between the air outlets and the smoke inlets, such that the possibility of the oil smoke overflowing out can be further reduced, and the adsorption and filtering effect on the oil smoke is better.

### Embodiment 2

A smokeless cooking appliance provided by Embodiment 2 is formed by further adding two wind gathering devices based on the structure of Embodiment 1, and other components remain unchanged.

In Embodiment 1, the smoke guiding devices 14 are provided with a plurality of open smoke guiding ports in a grid shape on a housing thereof, so that after being discharged from the air outlets 36 of the air guide pipe fittings 3, the oil smoke enters the smoke guiding devices 14 and is discharged through openings of the smoke guiding ports; and although such the smoke guiding ports may guide the oil smoke to positions near the air blowers, due to their structures, the oil smoke guiding effect still needs to be improved. Moreover, as the air guide pipe fittings 3 and the smoke guiding devices 14 are connected and attached not closely enough, it is hard for the oil smoke discharged from the air outlets 36 of the air guide pipe fittings 3 to completely and efficiently pass through the smoke guiding ports.

In view of this, the smokeless cooking appliance provided by Embodiment 2 is formed by adding the wind gathering devices 10 between the original air guide pipe fittings 3 and smoke guiding devices 14.

The air outlets 36 of the air guide pipe fittings 3 are in communication with inner cavities of the wind gathering devices 10. The wind gathering devices 10 are provided with a plurality of smoke discharge windows 101 for discharging oil smoke. The smoke discharge windows 101 are disposed toward the smoke extraction devices 5. The number and positions of the smoke discharge windows 101 are in one-to-one correspondence with the number and positions of the air outlets 36 of the air guide pipe fittings 3. Specifically, the wind gathering plates 102 are disposed on edges of the smoke discharge windows 101 in a protruding manner, wind gathering passages 103 are formed between the wind gathering plates 102, and a cross-sectional area of the wind gathering passage 103 gradually decreases along an extending direction of the wind gathering plate 102, such that smoke discharged from the smoke discharge windows 101 is limited and guided by the wind gathering plates 102 and discharged from the interiors of the wind gathering passages 103 to form concentrated airflows.

When food materials are heated, oil smoke will be produced above the cooking assembly 4. The two smoke extraction devices 5 drive to suck oil smoke into the fan flue 2 on two sides from the smoke inlets 24, and the oil smoke on the two sides passes through the first downward air flue 25 and the second downward air flue 26 respectively, is discharged from the smoke outlets and enters the interiors of the air guide pipe fittings 3. The oil smoke is discharged out of the air outlets 36 after passing through the air guide pipe fittings 3, and enters the interiors of the wind gathering devices 10. The wind gathering devices 10 are designed with the wind gathering plates 102, and the wind gathering passages 103 that gradually narrow down along a smoke outlet direction are formed between the wind gathering plates 102, such that after the oil smoke is acted by the wind gathering devices 10, the wind will be blown outward more intensively, forming more concentrated airflows; and the airflows are blown correspondingly to the plurality of air outlets 36, forming stronger and more concentrated “wind curtains”. The wind gathering devices 10 are disposed toward the smoke extraction devices 5. The “wind curtains” blown out will be sucked into the fan flue 2 again by the smoke extraction devices 5, and the oil smoke continuously circulates in this way, thereby achieving the effect of preventing the oil smoke from overflowing out.

Compared with Embodiment 1, in Embodiment 2 of the present disclosure, the wind gathering devices 2 are added, such that, when the oil smoke is discharged again to above the cooking assembly 4, the more concentrated outgoing airflows and more elongated “wind curtains” are formed, which is more beneficial for the smoke extraction devices 5 to suck a large amount of these smoke in again, without causing overflowing due to an excessively large scattered area of the oil smoke and accordingly affecting an indoor air environment. It is understandable that the present disclosure has a significantly better smokeless cleaning effect and less pollution to the indoor air and also reduces potential threats of the oil smoke to human health.

Specifically, the bottoms of the wind gathering devices 10 are provided with bottom openings, which are connected to the air outlets 36 of the air guide pipe fittings 3, such that the oil smoke can enter the interiors of the wind gathering devices 10 via the air guide pipe fittings 3. More specifically, air flue structures 104 are formed inside the wind gathering devices 10 along a height direction to allow oil smoke to pass through; bottom ends of the air flue structures 104 correspond to the bottom openings, such that wide smoke inlet ends 1041 are formed, ensuring the pass-through capacity and efficiency of smoke entering the wind gathering devices 10; one side of the air flue structures 104 along the smoke discharge windows 101 gradually and smoothly narrows down and forms passage structures similar to a conical shape, such that narrow smoke outlet ends 1042 are formed on one side of the air flue structures 104 corresponding to the smoke discharge windows 101. Certainly, the cross-sectional area of the narrow smoke outlet end 1042 is smaller than the cross-sectional area of the wide smoke inlet end 1041. Such the air flue structures 104 can enable the airflows to gradually tend to be concentrated when passing through the inner cavities of the wind gathering devices 10, and under a guiding effect of the air flue structures 104, the airflows are gradually concentrated.

Preferably, a plurality of flue baffles 33 are disposed inside the air guide pipe fitting 3 along a direction of a smoke pipe, the flue baffles 33 divide the interior of the air guide pipe fitting 3 into a plurality of air cavities 34, and each of the air cavities 34 corresponds to one air outlet 36 of the air guide pipe fitting 3, such that the air guide pipe fitting 3 has the plurality of air outlets 36 (are exemplarily four air outlets 36 on a single side in the figure) arranged, thereby forming a wind outgoing form similar to the “wind curtains” on the edges of the cooking assembly 4.

Correspondingly, a plurality of air flue structures 104 that are not in communication with each other are disposed inside the wind gathering device 10 along a length direction; and a bottom opening of each of the air flue structures 104 is correspondingly in communication with one air outlet 36 of the air guide pipe fitting 3, such that a wind outgoing structure form of the “wind curtains” is formed on two sides of the cooking assembly 4 after oil smoke is discharged from the interiors of the wind gathering devices 10.

Preferably, a bottom end of the wind gathering plate 102 is fixed to an edge of the smoke discharge window 101, a top end of the wind gathering plate 102 is of a pointed end structure, and the pointed end structure helps to further improve the wind gathering effect, thereby further gathering the airflows when the airflows pass through tail ends of the wind gathering passages 103.

Preferably, two wind gathering plates 102 are oppositely disposed on each of the smoke discharge windows 101, and a wind gathering passage 103 is formed between the two wind gathering plates 102.

Preferably, each of the air outlets 36 of the air guide pipe fittings 3 corresponds to an end portion of each of the air cavities 34, and the air outlets 36 of the two air guide pipe fittings 3 are disposed along the edges of the cooking assembly 4. Correspondingly, the two wind gathering devices 10 are also disposed along the edges of the cooking assembly 4 and blow the air along the two sides of the cooking assembly 4.

The foregoing is merely a preferred embodiment of the present disclosure and is not intended to limit the present disclosure which may be subject to various modifications and variations to those skilled in the art. Any modification, equivalent replacement, improvement, etc. made within the spirit and principles of the present disclosure should be included in the scope of protection of the present disclosure.

What is claimed is:

1. A smokeless cooking appliance, comprising
a cooking assembly;
a fan flue, wherein the fan flue is disposed above a heating region of the cooking assembly in a crossing manner, the fan flue is provided with smoke inlets, the smoke inlets are disposed above the heating region of the cooking assembly, a first downward air flue and a second downward air flue are disposed downward on the fan flue along two sides of the smoke inlets respectively, and lower end portions of the first downward air flue and the second downward air flue are provided with smoke outlets respectively;
smoke extraction devices, wherein the smoke extraction devices are mounted at the smoke inlets, and the smoke extraction devices are respectively in communication with the smoke outlets of the first downward air flue and the second downward air flue; and
two air guide pipe fittings, wherein air inlets of the two air guide pipe fittings are respectively in communication with the smoke outlets of the first downward air flue and the second downward air flue; and each of the air guide pipe fittings is provided with air outlets, and the air outlets are respectively located on two sides of the cooking assembly.

2. The smokeless cooking appliance according to claim 1, wherein
a plurality of flue baffles are disposed inside the air guide pipe fittings along a direction of a smoke pipe, the flue baffles divide the interiors of the air guide pipe fittings into a plurality of air cavities, and each of the air cavities corresponds to one air outlet of the air guide pipe fittings.

3. The smokeless cooking appliance according to claim 2, wherein
each of the air outlets corresponds to an end portion of each of the air cavities, and the air outlets of the two air guide pipe fittings are respectively disposed along edges of the cooking assembly.

4. The smokeless cooking appliance according to claim 1, wherein
smoke guiding devices are disposed at the air outlets, the air outlets are correspondingly in communication with the smoke guiding devices, and smoke guiding ports of the smoke guiding devices are disposed toward the smoke inlets.

5. The smokeless cooking appliance according to claim 4, further comprising:
wind gathering devices, wherein the air outlets of the air guide pipe fittings are in communication with inner cavities of the wind gathering devices; the wind gathering devices are provided with a plurality of smoke discharge windows for discharging oil smoke, and the smoke discharge windows are disposed toward the smoke extraction devices; and wind gathering plates are disposed on edges of the smoke discharge windows in a protruding manner, wind gathering passages are formed between the wind gathering plates, and the cross-sectional area of each of the wind gathering passages gradually decreases along an extending direction of the wind gathering plates; and
the wind gathering passages are in one-to-one correspondence with the smoke guiding ports, and openings of the wind gathering passages are closely attached to the smoke guiding ports.

6. The smokeless cooking appliance according to claim 5, wherein
a plurality of air flue structures are formed inside the wind gathering devices along a height direction; wide smoke inlet ends are formed at one end of the air flue structures corresponding to the air guide pipe fittings, and one side of the air flue structures along the smoke discharge windows gradually and smoothly narrows down and forms conical passages, such that narrow smoke outlet ends are formed at one end of the air flue structures corresponding to the smoke discharge windows; and
a cross-sectional area of each of the narrow smoke outlet ends is smaller than the cross-sectional area of each of the wide smoke inlet ends.

7. The smokeless cooking appliance according to claim 6, wherein
the plurality of air flue structures that are not in communication with each other are disposed inside the wind gathering devices along a length direction thereof; and a bottom opening of each of the air flue structures is correspondingly in communication with one air outlet of the air guide pipe fittings.

8. The smokeless cooking appliance according to claim 5, wherein
bottom ends of the wind gathering plates are fixedly connected to the edges of the smoke discharge windows, and top ends of the wind gathering plates are of a pointed-end structure.

9. The smokeless cooking appliance according to claim 4, further comprising:
a shell, wherein an upper portion of the shell is provided with an accommodating cavity, two sides of the accommodating cavity are provided with a first through hole and a second through hole respectively, the cooking assembly is mounted in the accommodating cavity, the two air guide pipe fittings are mounted below the shell respectively, and two lower ports of the fan flue are respectively in communication with the air guide pipe fittings via the first through hole and the second through hole.

10. The smokeless cooking appliance according to claim 9, wherein
the smoke guiding devices are disposed on an upper surface of the shell corresponding to the air outlets of the air guide pipe fittings, and the smoke guiding devices and the upper surface of the shell are integrally formed or fixedly connected.

11. The smokeless cooking appliance according to claim 10, wherein
the cooking assembly comprises a heating plate, a first connection box and a second connection box are respectively disposed on two sides of the heating plate, a third through hole is provided at a position of the first connection box corresponding to the first through hole, and a fourth through hole is provided at a position of the second connection box corresponding to the second through hole; and
the two lower ports of the fan flue are respectively inserted in the third through hole and the fourth through hole.

12. The smokeless cooking appliance according to claim 11, wherein
an oil collecting tray for collecting oil and impurities dropping from the heating plate is disposed below the heating plate, and the oil collecting tray is mounted in the accommodating cavity.

13. The smokeless cooking appliance according to claim 1, wherein
two baffles are disposed inside a cross beam of the fan flue, the two baffles divide the fan flue into two spaces that are not internally in communication with each other, fan mounting grooves are respectively disposed at positions in the two spaces correspondingly right above the cooking assembly, the fan mounting grooves are in communication with the interior of the fan flue, the smoke extraction devices are mounted in the two fan mounting grooves respectively, and air outlets of the two smoke extraction devices are respectively in communication with two ports at bottoms of the fan flue.

14. The smokeless cooking appliance according to claim 13, wherein
the fan flue comprises a flue main body, a flue cover plate is detachably mounted at a bottom of the flue main body, the fan mounting grooves are disposed in the flue main body, the smoke inlets are disposed on the flue cover plate, and the smoke inlets correspond to positions of the fan mounting grooves.

15. The smokeless cooking appliance according to claim 1, wherein
first filter screens are mounted at the smoke inlets and used for the adsorption and filtering of oil smoke.

16. The smokeless cooking appliance according to claim 11, further comprising:
a base, wherein the base is fixedly connected to a lower portion of the shell, and the air guide pipe fittings are accommodated inside the base.

17. The smokeless cooking appliance according to claim 1, wherein
the smoke extraction devices are negative-pressure air blowers.

18. The smokeless cooking appliance according to claim 15, wherein
each of the first filter screens comprises a filter screen frame, a filter screen is mounted on an inner side of the filter screen frame, a mounting through hole is provided in the center of the filter screen, and an oil storage cap is detachably mounted in the mounting through hole.

19. The smokeless cooking appliance according to claim 18, wherein
an edge of an opening of the oil storage cap extends outward to form a brim, and the outer diameter of the brim is greater than the inner diameter of the mounting through hole.

20. The smokeless cooking appliance according to claim 18, wherein
two convex blocks protruding outward are further provided at a bottom of the filter screen frame, facilitating rotary snap-fitting of the first filter screens during the mounting.
